(19) United States
(12) Patent Application Publication
(10) Pub. No.: US 2016/0368588 A1
(43) Pub. Date: Dec. 22, 2016

(54) EXTRUDED PRODUCTS FOR AEROPLANE FLOORS MADE OF AN ALUMINIUM-COPPER-LITHIUM ALLOY

(71) Applicant: CONSTELLIUM ISSOIRE, Issoire (FR)

(72) Inventors: Jérome PIGNATEL, La Chapelle sur Erdre (FR); Gaëlle POUGET, Grenoble (FR)

(21) Appl. No.: 15/100,803

(22) PCT Filed: Dec. 10, 2014
(86) PCT No.: PCT/FR2014/000264

§ 371 Date: Jun. 1, 2016

(30) Foreign Application Priority Data
Dec. 13, 2013 (FR) 13/02931

(51) Int. Cl. B64C 1/18; C22C 21/16; B64C 1/06; C22F 1/057; B64C 3/00; C22C 21/18; C22C 21/14

(52) U.S. Cl. CPC B64C 1/18; C22C 21/18; C22C 21/16; C22C 21/14; C22F 1/057; B64C 3/00; B64C 1/061; B64C 2001/0081

(57) ABSTRACT

The invention relates in particular to an unprocessed extruded product for manufacturing a machined extruded product for the aeronautical industry, made of an Al—Cu—Li alloy. The invention also relates to the method for manufacturing a machined extruded product and to the corresponding machined extruded product. The products according to the invention are useful in particular for manufacturing floor beams and girders.

### FIELD OF THE INVENTION

The invention relates to extruded products made of aluminum-copper-lithium alloy, more particularly, of such products, their methods of manufacturing and their use, intended in particular for aeronautical and aerospace construction.

### PRIOR ART

Extruded products made of aluminum alloy are developed to produce high resistance parts intended in particular for the aeronautical industry and the aerospace industry.

The extruded products made of aluminum alloy are used in the aeronautical industry for many applications, such as fuselage stiffeners and stringers, fuselage frames, wing stiffeners, floor beams and cross beams as well as seat tracks.

The method for manufacturing extruded products made of Al—Cu—Li alloy used in the aeronautical industry includes a step of manufacturing an raw extruded product, by the steps of casting, homogenization, extrusion, solution-heat treating, quenching, stress relieving by controlled traction and artificially aged. However, the raw extruded product is not used in that state and is then machined in such a way as to obtain a machined extruded product having the desired surface quality and geometrical characteristics. The raw extruded product is usually dimensioned in such a way that the machined product can be obtained by machining limited to a few millimeters in such a way as to limit the loss of metal while still obtaining the desired quality.

Certain extruded products used in the aeronautical industry have parts that have a low aspect ratio and parts that have a high aspect ratio. Generally, the term “core” is used to refer to central parts having a high aspect ratio and “flank” part with a low aspect ratio, of which the direction of the length or of the thickness is substantially perpendicular to the lengthwise direction of the core.

Flanks are commonly used to carry out fastening after having been drilled in such a way as to introduce therein fastening elements such as screws. It is known that the mechanical properties are often less favorable in the flanks than in the core.

U.S. Pat. No. 6,113,711 describes a method for manufacturing extruded products made of an aluminum alloy containing lithium wherein parts with a low aspect ratio are obtained by extrusion in a tortuous path in such a way as to improve their mechanical properties. However this tortuous path makes the extrusion method delicate.

U.S. Patent application 2005/0241735 describes an extruded product for stiffeners having quantities increased with texture fibers, with the desired texture being obtained by extrusion axisymmetric areas and by removing the excess metal.

Application W02008/012570 describes a method for manufacturing a stiffener for aircraft wherein an unmachined form of the stiffener is produced with spaced edges having a casing comprising all of the desired sections for the machined stiffeners.

Application US 2013/025539 describes an extruded, rolled or forged product made of Al—Cu—Li alloy having improved properties in particular in terms of a compromise between the static mechanical properties and the tolerance to damage.

There is a need for extruded products made of aluminum-copper-lithium alloy having improved properties in areas with a low aspect ratio, in particular in terms of a compromise between the properties of static mechanical resistance and of tenacity and in terms of resistance to folding after drilling.

### OBJECTS OF THE INVENTION

A first objet of the invention is a method for manufacturing a machined extruded product for the aeronautical industry having a machined core (11) and at least one machined flank (12) wherein

(a) a raw form made of Al—Cu—Li alloy is cast with the following composition, as weight percentages, Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si 0.1; Fe≦0.1; others ≦0.05 each and ≦0.15 in total, the balance being aluminum,

(b) said raw form is homogenized,

(c) said raw form is hot worked by extrusion in such a way as to obtain an raw extruded product (2) having an raw core (21) and at least one raw flank (22),

(d) said raw extruded product is solution-heat treated

(e) said raw extruded product solution-heat treated is quenched,

(f) said raw extruded product is stretched in a controlled manner

(g) optionally a straightening or a forming of said extruded product is carried out,

(h) said raw extruded product is artificially aged

(i) said raw extruded product is machined in order to obtain a machined extruded product having a machined core (11) and at least one machined flank (12) corresponding to the raw flank (22) characterized in that the dimension of said raw flank (E22 or L22), of which the direction is perpendicular to the dimension of the length (L21) of said raw core, is at least 20% greater than the length of said machined flank (L12).

Another object of the invention is a raw extruded product for the manufacture of a machined extruded product for the aeronautical industry, made of an Al—Cu—Li alloy with the following composition, as weight percentages: Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si 0.1; Fe≦0.1; others ≦0.05 each and ≦0.15 in total, the balance being aluminum, having a raw core (21) of which the aspect ratio is at least 5 and at least one raw flank (22) of which the aspect ratio is less than 4 and of which the direction of the length is substantially perpendicular to the lengthwise direction of the core characterized in that a portion of said raw flank (22) connecting said raw flank to said raw core has a decreasing thickness and in that the ratio of the thickness of said raw flank (22) for the end of said raw flank connected to the core (E221) and for the end thereof opposite the core (E222), i.e. E221/E222, is less than 0.8 and preferably less than 0.6 thus defining two substantially symmetrical concave areas.

Yet another object of the invention is a machined extruded product for the aeronautical industry able to be obtained by the method according to the invention, made of an Al—Cu—Li alloy with the following composition, as weight percentages: Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si 0.1; Fe≦0.1; others ≦0.05 each and ≦0.15 in total, the balance being aluminum, having a machined core (11) of which the aspect ratio is at least 20 and at least one machined flank (12) of which the aspect ratio is less than 15 and of which the direction of the length is substantially perpendicular to the lengthwise direction of the core characterized in that its granular structure is substantially non-recrystallized and in that between the mid-length of said machined flank and said machined core the direction of the length of the grain is substantially parallel to the lengthwise direction of the flank.

### DESCRIPTION OF THE FIGURES

FIG. 1: General diagram of a machined extruded product for the aeronautical industry

FIG. 2: General diagram of a raw extruded product and of the corresponding machined extruded product.

FIG. 3: Detail of a core and of a flank according to prior art (FIG. 3a) and according to the invention (FIG. 3b)

FIG. 4: Detail of a core and of a flank according to a preferred embodiment of the invention.

FIG. 5: Detail of the orientation of the grains for machined extruded products according to prior art (FIG. 5a) and according to the invention (FIGS. 5b and 5c).

### DESCRIPTION OF THE INVENTION

Unless mentioned otherwise, all of the indications concerning the chemical composition of the alloys are expressed as a weight percentage based on the total weight of the alloy. The expression 1.4 Cu means that the copper content expressed as a weight % is multiplied by 1.4. The designation of the alloys is done in compliance with the regulations of The Aluminum

Association, known to those skilled in the art. The definitions of the tempers are indicated in European standard EN 515.

The static mechanical characteristics in traction, in other terms the ultimate tensile strength Rm, tensile yield strength at 0.2% elongation R_{p0.2}, and elongation at rupture A%, are determined by a tensile test according to the standard NF EN ISO 6892-1, with the sampling and the direction of the test being defined by the standard EN 485-1.

The stress intensity factor (K_{Q}) is determined according to the standard ASTM E399. The standard ASTM E399 gives the criteria that make it possible to determine if K_{Q} is a valid value of K_{1c}. For a given specimen geometry, the values of K_{Q} obtained for different materials can be compared with each other in so much as the limits of elasticity of the materials are of the same order of magnitude.

Unless mentioned otherwise, the definitions of the standard EN 12258 apply.

The inventors observed that, surprisingly, for certain aluminum-copper-lithium alloys, the properties of the flanks of a machined extruded product can be improved significantly by modifying the form of the corresponding raw extruded product.

In the method according to the invention, a raw form made of an Al—Cu—Li alloy is cast with the following composition, as weight percentages: Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si 0.1; Fe≦0.1; others ≦0.05 each and ≦0.15 in total, the balance being aluminum. Preferentially, the copper content is at least 2.2 wt % and/or at most 3.3 wt %. Preferentially, the lithium content is at least 1.2 wt % and/or at most 1.8 wt %. Preferentially, the magnesium content is at least 0.05 wt % and/or at most 0.8 wt %. Preferentially, the manganese content is at least 0.05 wt % and/or at most 0.5 wt %. Preferentially, the zirconium content is at least 0.06 wt % and/or at most 0.18 wt %. In an advantageous embodiment, manganese and zirconium are added simultaneously. Preferentially, the silver content is at least 0.1 wt % and/or at most 0.4 wt %. Preferentially, the zinc content is at least 0.05 wt % and/or at most 0.8 wt %. In an embodiment of the invention, at least 0.1 wt % of silver is added and the zinc content is limited to less than 0.2 wt %. Preferentially, the titanium content is at least 0.02 wt % and/or at most 0.10 wt %. Advantageous alloys to carry out the invention are in particular the AA2065, AA2195, AA2295, AA2196, AA2296, AA2076, AA2099, AA2199 alloys; alloys AA2196, AA2296, AA2076 are particularly preferred.

The raw form obtained as such is homogenized. The homogenization temperature is preferably between 480° C. and 540° C. for 5 to 60 hours. Preferably, the homogenization temperature is between 515° C. and 525° C. After homogenization, the raw form is in general cooled until ambient temperature before being heated for the purposes of hot working. The purpose of the preheating is to reach an initial hot working temperature more preferably between 400° C. and 500 ° C. and preferably of a magnitude from 450 ° C. to 480 ° C. allowing for the hot working of the raw form.

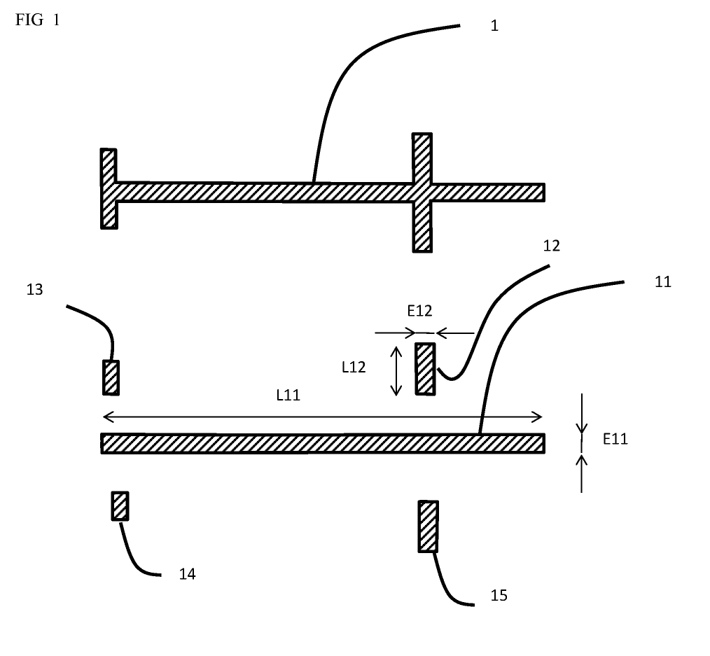

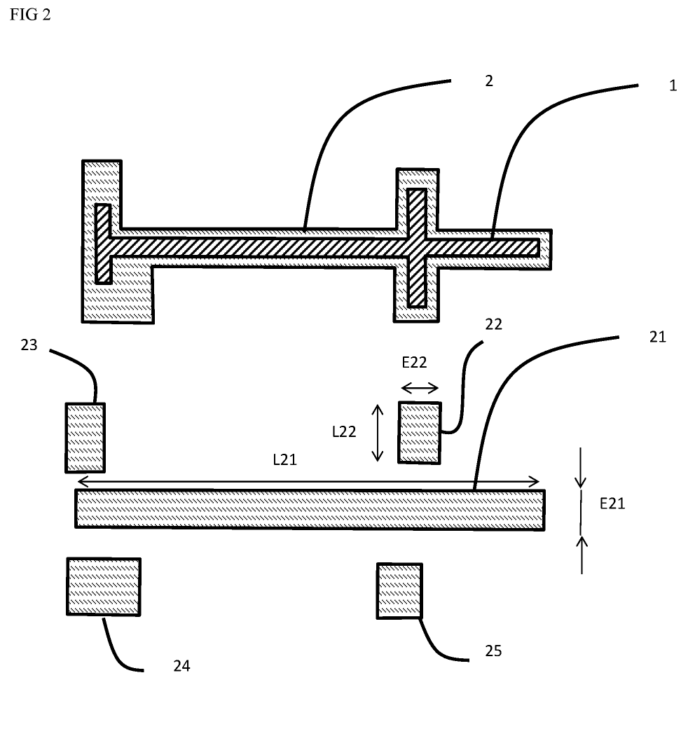

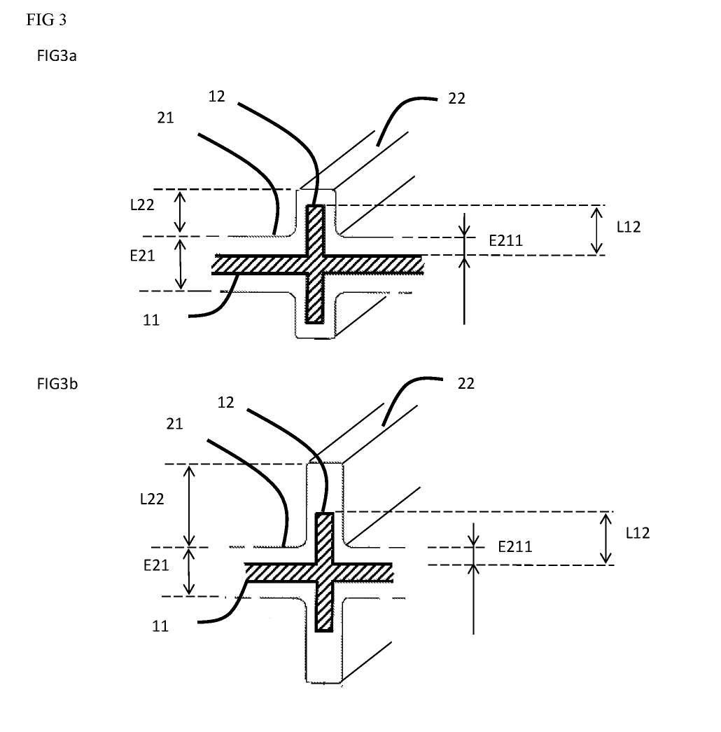

The hot working is carried out by extrusion in such a way as to obtain a raw extruded product. The form of the raw extruded product is defined according to the form of the machined extruded product that will be used in the aeronautical structure. In the framework of the invention the cross-section of the extruded product is divided into basic rectangles of dimensions L and E; with L always being the greatest dimension of the basic rectangle that will be referred to as length and E being the smallest dimension of the basic rectangle which will be referred to as thickness. The aspect ratio is the L/E ratio. The manner in with which the cross-section is divided into basic rectangles in the framework of the invention is shown in FIGS. 1 and 2. In the example shown in FIG. 1, the machined extruded product (1) is divided into 5 basic rectangles, (11, 12, 13, 14 and 15) by starting with the basic rectangle that has the highest aspect ratio (11) and so on. Likewise, the raw extruded product (2) is divided into 5 basic rectangles, (21, 22, 23, 24 and 25) by starting with the basic rectangle that has the highest aspect ratio (21) and so on. The invention relates to raw extruded products having a basic rectangle (21), that shall be referred to as “raw core” having an aspect ratio of at least 5 and preferably at least 8 or even 10 and at least one basic rectangle (12, 13, 14, 15) that shall be referred to as “raw flank” with an aspect ratio less than 4 of which the direction of the length or of the thickness is substantially perpendicular to the lengthwise direction of the core and/or the machined extruded products having a basic rectangle (11), that shall be referred to as “machined core” having an aspect ratio of at least 20 or even at least 30 and at least one basic rectangle with an aspect ratio less than 15 (12, 13, 14, 15), that shall be referred to as “machined flank” of which the direction of the length is substantially perpendicular to the lengthwise direction of the core. FIG. 2 shows an example of a cross-section of raw extruded product (2) corresponding to a machined extruded product (1). Figure shows four raw flanks (22, 23, 24 and 25). The dimension of the raw flank of which the direction is perpendicular to the lengthwise direction of the raw core can be the length (case of raw flanks 22, 23, 25) or the thickness (case of the raw flank 24). According to the invention, the dimension of the raw flank (E22 or L22) of which the direction is perpendicular to the dimension of the length (L21) of the raw core is at least 20% greater, preferably at least 50% greater and further preferably at least 80% greater than the length of the machined flank (L12) of which the direction is perpendicular to the direction of the length (L11) of the machined core. Advantageously the aspect ratio of the raw flank is at least 1.1. In an embodiment of the invention, the aspect ratio of the raw flank is at least 1.5 and preferably at least 2. Preferentially the dimension of the raw flank of which the direction is perpendicular to the lengthwise direction of the raw core is the length. FIG. 3a shows an example of a raw extruded product according to prior art, having a raw core (21) shown partially and a raw flank (22) allowing for the machining of a machined extruded product having a machined core (11), shown partially, and a machined flank (12). In the framework of the invention, the raw flank (22) corresponds to the machined flank (12). For the same machined extruded product, FIG. 3b shows an example of a raw product according to the invention, having a raw core (21) shown partially and a raw flank (22). According to the invention, the length of the raw flank (L22) is at least 20% greater than the length of the machined flank (L12). Advantageously, if consideration is given to the thickness (E211) of the raw core (21) which has been machined in the face corresponding to a raw flank (22) and the dimension of the raw flank (E22 or L22) of which the direction is perpendicular to the dimension of the length (L21), these magnitudes are such that their sum is more than 50% greater and more preferably more than 80% greater than the length of the machined flank (L12).

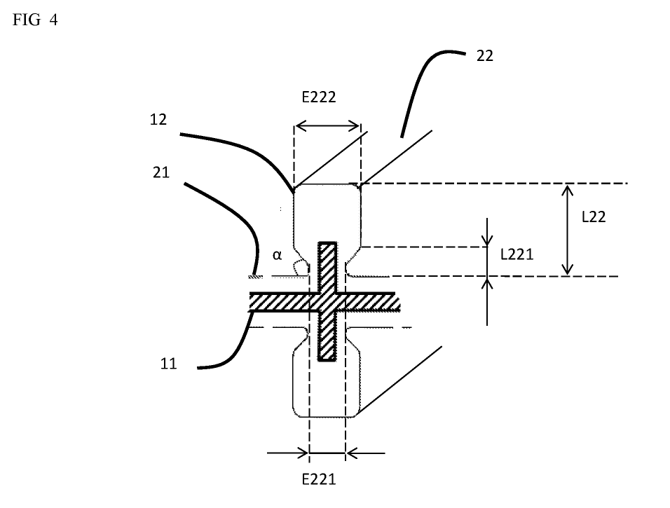

An advantageous embodiment of the invention is shown in FIG. 4. The flank (22) has in the area connected to the core a portion of decreasing thickness. In the framework of the invention, in the case of a continuous change in the thickness, the divisor is considered to be the cross-section in basic rectangles with the basic rectangle encompassing the portion that locally has a variable thickness. In this advantageous embodiment, the ratio between the thickness of the raw flank (22) for the end of the raw flank connected to the core (E221) and for the end thereof opposite the core (E222), i.e. E221/E222, is less than 0.8 and preferably less than 0.6 thus defining two substantially symmetrical concave areas. Advantageously the portion of the raw flank for which the thickness is decreasing extends over a length (L221) less than 30% of the total length of the flank (L22). Preferentially, in this embodiment, the angle (α) between the lengthwise direction of the raw core (21) and the direction corresponding to the decrease in the thickness of the flank is 45 +/−10°. As shown in FIG. 4, the angle (α) is an angle of the triangle rectangle of which a first side is defined by the lengthwise direction of the raw core (L21) and a second side corresponds to the length (L221), said angle (α) being opposite the second side corresponding to the length (L221). Advantageously and as shown in FIG. 4, the decrease of the raw flank is linear in a first part of which the length projected over a straight line parallel to the lengthwise direction of the raw core (L21) is equal to ((E222-E221)/2), with the second part being a concave area.

Preferentially the radius of curvature for the connection of the raw flank (22) and of the core (21) is between 2 and 4 mm. In the embodiment according to FIG. 4, the aspect ratio of the raw flank is advantageously between 1.2 and 1.5.

The invention is more particularly advantageous for the raw extruded products of which the thickness of the core (E21) is at least 12 mm and preferably at least 15 mm. The thickness of the flanks (E22) of the raw extruded products is advantageously at least 10 mm and preferably at least 15 mm. In the embodiment shown in FIG. 4, the thickness E222 is advantageously at least 20 mm and the thickness E221 is advantageously at least 10 mm.

The raw extruded product obtained such is then solution-heat treated and quenched. Advantageously the solution-heat treatment is carried out at a temperature between 490° C. and 540° C. for 15 min to 8 h and more preferably between 510° C. and 530° C. for a duration between 20 min and two hours.

The raw extruded product as such solution-heat treated and quenched then in stretched in a controlled manner, more preferably from 1 to 5% and preferentially of at least 2%. Known steps such as straightening or forming can optionally be carried out before or after the controlled stretching.

An artificial ageing is carried out preferentially at a temperature between 120 and 170° C. for 5 to 100 h preferentially between 150 and 160° C. for 20 to 60 h.

The raw extruded product is then machined in order to obtain the machined extruded product that is used in the aeronautical structure. The raw extruded product can in particular be machined in order to obtain a wing stiffener, a fuselage stiffener, a fuselage frame, a floor beam or a floor cross beam. Preferentially the machined extruded product is a floor cross beam.

The thickness of the core (E11) of the machined extruded product is advantageously between 2 and 14 mm. The length of the core (L11) of the machined extruded product is advantageously at least 150 mm, preferably at least 220 mm and more preferably at least 240 mm. The length of the flanks of the machined product is advantageously at least 10 mm, preferably at least 12 mm or preferably at least 15 mm and the thickness of the flanks of the machined extruded product is advantageously at least 2 mm, preferably at least 3 mm.

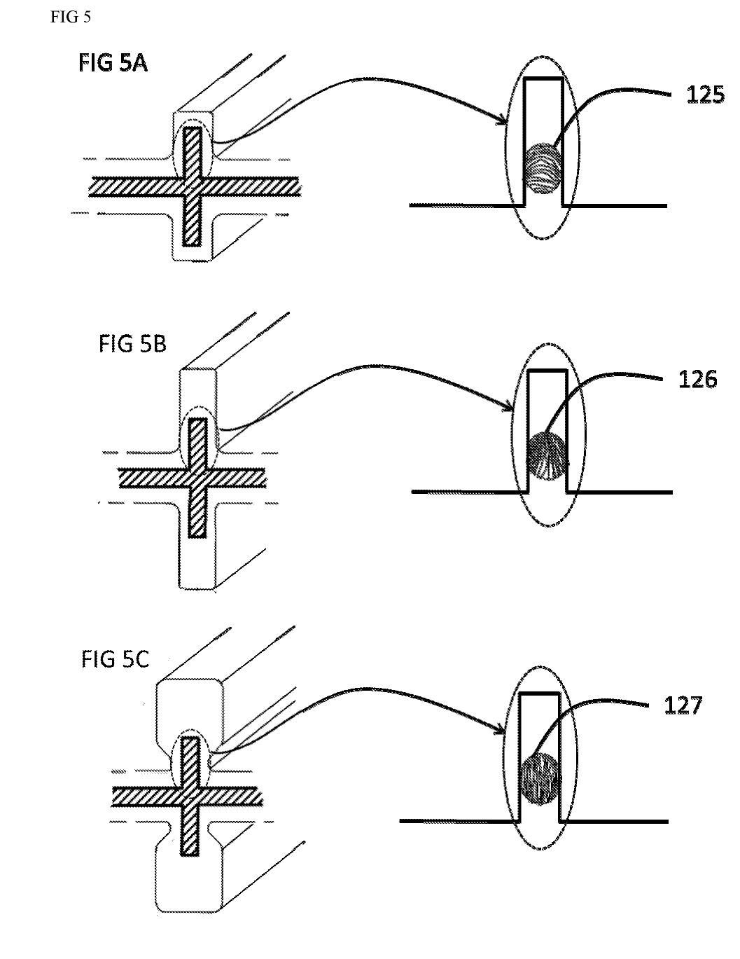

The method according to the invention makes it possible to obtain a structure and an orientation of grains that is advantageous in the flanks of the machined extruded products, in particular between mid-length of the flank and the core. The granular structure of the machined products obtained by the method according to the invention is substantially non-recrystallized, with the rate of recrystallized grains being less than 10%. FIG. 5 shows the orientation of the grains in the zone of the machined flank between mid-length of the machined flank and the machined core. For a machined extruded product according to prior art (FIG. 5A) the direction of the length of the grains (125) between the mid-length of the machined flank and the machined core is substantially parallel to the lengthwise direction of the core. For a machined extruded product according to the invention (FIGS. 5B and 5C), the direction of the length of the grains between the mid-length of the machined flank and the machined core is substantially parallel to the lengthwise direction of the flank (126, 127). In the advantageous embodiment shown in FIG. 4 and FIG. 5C, the difference between the direction of the length of the grains and the direction of the length of the flanks is less than 10°.

The inventors think that, in particular, the granular structure obtained from the machined extruded product but also perhaps other factors such as the local texture, obtained thanks to the method according to the invention allow for the observed improvement in properties. As such, the tenacity of the machined extruded products according to the invention is in the flank according to the invention, in the direction S-L, increased by at least 20% and even in certain cases by more than 50% in relation to method according to prior art.

Advantageously for raw and/or machined extruded products according to the invention the limit of elasticity in the longitudinal direction of the raw flanks and of the machined flanks is at least 450 MPa and preferably at least 460 MPa and the tenacity K_{IC S-L} is at least 15 MPa √m and preferably at least 16 MPa √m. In addition, the resistance to folding of the machined flanks after drilling of an orifice between the core and the mid-length is significantly improved.

The machined extruded products according to the invention are particularly advantageous as a structural element for aeronautical construction. As such, the machined extruded products according to the invention are advantageously used for aeronautical construction as a wing stiffener, fuselage stiffener, fuselage frame, floor beam or a floor cross beam. In a preferred embodiment the products according to the invention are used as a floor cross beam.

### EXAMPLE

In this example, machined extruded products made of an AA2196 alloy were prepared. The products C, D and E have a raw flank such that the dimension of said raw flank of which the direction is perpendicular to the dimension of the length of the raw core is at least 20% greater than the length of the machined flank.

Raw forms made of an AA2196 alloy were cast and homogenized at about 520° C.

The raw forms were extruded in such a way as to obtain raw profiles having a core with a length and at least one flank of which the characteristics are given in table 1

TABLE 1
Geometrical characteristics of raw profiles

| | Core | Core | Flank | Flank |
|---|---|---|---|---|
| | length | Thickness | length | thickness |
| | (mm) | (mm) | (mm) | (mm) |
| A* | 242 | 21 | 20 | 16 |
| B* | 242 | 30 | 22 | 20 |
| C^{α} | 242 | 25 | 25 | 15 |
| D^{α} | 242 | 21 | 36 | 15 |
| E^{α}** | 242 | 21 | 36 | 28 |

*direction of the thickness of the flank perpendicular to the lengthwise direction of the core
^{α}direction of the length of the flank perpendicular to the lengthwise direction of the core
**according to the diagram of FIG. 4, the thickness of the raw flank (22) is 15 mm for the end of the raw flank connected to the core (E221) and 28 mm for the end opposite the core (E222), the portion of the raw flank for which the thickness is decreasing and less than 28 mm (L221) is 10 mm, the angle (α) between the lengthwise direction of the raw core (21) and the direction corresponding to the decrease in the thickness of the flank was 45°, the radius of curvature for the connection of said raw flank (22) and of the core (21) was between 2.5 and 3 mm.

The raw extruded products obtained as such were solution-heat treated at about 520° C. and quenched then stress relieved via controlled traction and artificially aged. They were then machined in order to obtain machined profiles that have the following characteristics: the length of the machined core was about 240 mm, the thickness of the machined core was environ 5 mm, the length of the machined flank was 20 mm and its thickness was 2 mm.

The mechanical properties of the flanks were characterized. The results are given in table 2. A 3-point bending test was carried out after drilling in the machined flank, between the core and the mid-length, of a hole. The qualitative results with regards to the bending of the flank are given in table 2:−strong significant strong deviation of the flank (−−: very strong) and +significant low deviation of the flank (++: very low).

TABLE 2
Mechanical properties

| | Rm | Rp02 | | K_{1C} (S-L) | Test |
|---|---|---|---|---|---|
| | (MPa) | (MPa) | A % | MPa √m | flexion |
| A | 547 | 496 | 4.3 | 14 | − − |
| B | 534 | 486 | 4.3 | 11 | − − |
| C | 565 | 515 | 5.3 | 17 | + |
| D | 525 | 471 | 3.8 | 21 | + |
| E | 524 | 472 | 4.4 | 17 | + + |

The static mechanical characteristics and the tenacity were measured after specimen sampling in the raw flanks of the raw extruded products, in the longitudinal direction of the raw flanks for Rₘ, Rp0.2 and A % in the zone corresponding to that of the flanks of the machined profiles. The characteristics of the bending test were observed on the machined profiles.

1. Method for manufacturing a machined extruded product for the aeronautical industry having a machined core and at least one machined flank wherein
(a) a raw form made of an Al—Cu—Li alloy is cast with the following composition, as weight percentages: Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si≦0.1; Fe≦0.1; others ≦0.05 each and ≦0.15 in total, the balance being aluminum,
(b) said raw form is homogenized,
(c) said raw form is hot worked by extrusion in such a way as to obtain a raw extruded product having a raw core and at least one raw flank.
(d) said raw extruded product is solution-heat treated
(e) said raw extruded product solution-heat treated is quenched,
(f) said raw extruded product is stretched in a controlled manner (g) optionally a straightening or a forming of said extruded product is carried out, (h) said raw extruded product is artificially aged (i) said raw extruded product is machined in order to obtain a machined extruded product having a machined core and at least one machined flank corresponding to the raw flank
wherein the dimension of said raw flank of which the direction is perpendicular to the dimension of the length of said raw core is at least 20% greater than the length of said machined flank.

2. Method according to claim 1 wherein the thickness of the raw core that was machined on the face corresponding to a raw flank and the dimension of said raw flank of which the direction is perpendicular to the dimension of the length, as such that their sum is more than 50% greater optionally more than 80% greater than the length of the machined flank.

3. Method according to claim 1 wherein a portion of said raw flank connecting said raw flank to said raw core has a decreasing thickness and in that the ratio of the thickness of said raw flank for the end of said raw flank connected to the core and for the end thereof opposite the core, is less than 0.8 and optionally less than 0.6 thus defining two substantially symmetrical concave areas.

4. Method according to claim 3 wherein said portion of said raw flank for which the thickness is decreasing extends over a length less than 30% of the total length of the flank.

5. Method according to claim 3 wherein the angle (α) between the lengthwise direction of the raw core and the direction corresponding to the decrease in the thickness of the flank is 45 +/−10°.

6. Raw extruded product for the manufacture of a machined extruded product for the aeronautical industry,
made of an Al—Cu—Li alloy with the following composition, as weight percentages: Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si≦0.1; Fe≦0.1; others ≦0.05 each and ≦0.15 in total, the balance being aluminum,
having a raw core of which the aspect ratio is at least 5 and at least one raw flank of which the aspect ratio is less than 4 and of which the direction of the length is substantially perpendicular to the lengthwise direction of the core, wherien a portion of said raw flank connecting said raw flank to said raw core has a decreasing thickness and in that the ratio of the thickness of said raw flank for the end of said raw flank connected to the core and for the end thereof opposite the core, is less than 0.8 and optionally less than 0 6 thus defining two substantially symmetrical concave areas;
the aspect ratio of the raw core or of the raw flank being the ratio L/E where L corresponds to the greatest dimension of the basic rectangle defined in the cross-section of the raw core or of the raw flank respectively and E corresponds to the smallest dimension of the basic rectangle defined in the cross-section of the raw core or of the raw flank respectively.

7. Raw extruded product according to claim 6 wherein said portion of said raw flank for which the thickness is decreasing extends over a length less than 30% of the total length of the flank.

8. Raw extruded product according to claim 6 wherein the angle (α) between the lengthwise direction of the raw core the direction corresponding to the decrease in the thickness of the flank is 45+/−10°.

9. Raw extruded product according to claim 6 wherein the radius of curvature for the connection of said raw flank and of the core is between 2 and 4 mm

10. Machined extruded product for the aeronautical industry able to be obtained by the method according to any of claim 1, made of an Al—Cu—Li alloy with the following composition, as weight percentages: Cu: 2.0-6.0; Li: 0.5-2.0; Mg: 0-1.0; Ag: 0-0.7; Zn 0-1.0; and at least one element selected among Zr, Mn, Cr, Sc, Hf and Ti, the amount of said element, if chosen, being 0.05 to 0.20 wt % for Zr, 0.05 to 0.8 wt % for Mn, 0.05 to 0.3 wt % for Cr and for Sc, 0.05 to 0.5 wt % for Hf and 0.01 to 0.15 wt % for Ti, Si≦0.1; Fe≦0.1; others ≦0.05 each and ≦0.15 in total, the balance being aluminum,
having a machined core of which the aspect ratio is at least 20 and at least one machined flank of which the aspect ratio is less than 15 and of which the direction of the length is substantially perpendicular to the lengthwise direction of the core, wherein a granular structure thereof has a rate of recrystallized grains less than 10% and in that between the mid-length of said machined flank and said machined core the direction of the length of the grain is substantially parallel to the lengthwise direction of the flank,
the aspect ratio of the machined core or of the machined flank being the ratio L/E where L corresponds to the greatest dimension of the basic rectangle defined in the cross-section of the machined core or of the machined flank respectively and E corresponds to the smallest dimension of the basic rectangle defined in the cross-section of the machined core or of the machined flank respectively.

11. Machined extruded product according to claim 10 wherein the difference between the direction of the length of the grains and the direction of the length of the flanks is less than 10°.

12. Use of a A machined extruded product according to claim 10 as a structural element for aeronautical construction.

13. Product according to claim 12 as a wing stiffener, fuselage stiffener, fuselage frame, floor beam or a floor cross beam, optionally a floor cross beam.
